(19) United States
(12) Patent Application Publication
(10) Pub. No.: US 2013/0056190 A1
(43) Pub. Date: Mar. 7, 2013

(54) COOLING STRUCTURE

(71) Applicants: Marcelo Bromberg, Simi Valley, CA (US); Cheng-Yi Lu, West Hills, CA (US)

(72) Inventors: Marcelo Bromberg, Simi Valley, CA (US); Cheng-Yi Lu, West Hills, CA (US)

(73) Assignee: HAMILTON SUNDSTRAND CORPORATION, Windsor Locks, CT (US)

(21) Appl. No.: 13/224,414

(22) Filed: Sep. 2, 2011

(51) Int. Cl. F28F 9/02; B23P 15/26

(52) U.S. Cl. 165/173; 29/890.052

(57) ABSTRACT

A heat exchanger structure includes a monolithic extrusion and a plurality of headers. The extrusion includes a first end; a second end; a first, smooth side; and a second side with a plurality of smooth portions alternating with a plurality of raised portions defining a plurality of parallel flow passages extending from the first end to the second end; and a plurality of headers connecting the plurality of flow passages to form a flow path.

### BACKGROUND

The present invention relates to cooling structures, and in particular, to an integrated monolithic cooling structure.

Traditional cooling structures, for example a radiator or a cooling plate, are heat exchangers used to transfer thermal energy from one medium to another. These heat exchangers typically rely on attaching coolant tubes to a plate to transfer heat to fluid running through the tubes. The cooling tubes are typically attached using thermally conductive epoxies, gaskets, brazed joints, or solder joints.

### SUMMARY

A heat exchanger structure includes a monolithic extrusion and a plurality of headers. The extrusion includes a first end; a second end; a first, smooth side; and a second side with a plurality of smooth portions alternating with a plurality of raised portions defining a plurality of parallel flow passages extending from the first end to the second end; and a plurality of headers connecting the plurality of flow passages to form a flow path.

A method of forming a heat exchanger structure includes forming an extrusion as a monolithic part with a first end, a second end, a first, smooth side and a second side with a plurality of smooth portions alternating with a plurality of raised portions defining a plurality of elongated flow passages extending from the first end to the second end; and joining the plurality of flow passages with a plurality of headers to form a flow path through the plurality of flow passages.

### BRIEF DESCRIPTION OF THE DRAWINGS

FIG. 1 is a perspective view of a modular segment of a cooling structure.

FIG. 2 is a cross-sectional view along section 2-2 of the cooling structure of FIG. 1.

FIG. 3 is a cross sectional view of a flow passage of prior art heat exchanger.

FIG. 4 is a cross-sectional view of a second embodiment of a modular segment of a cooling structure.

### DETAILED DESCRIPTION

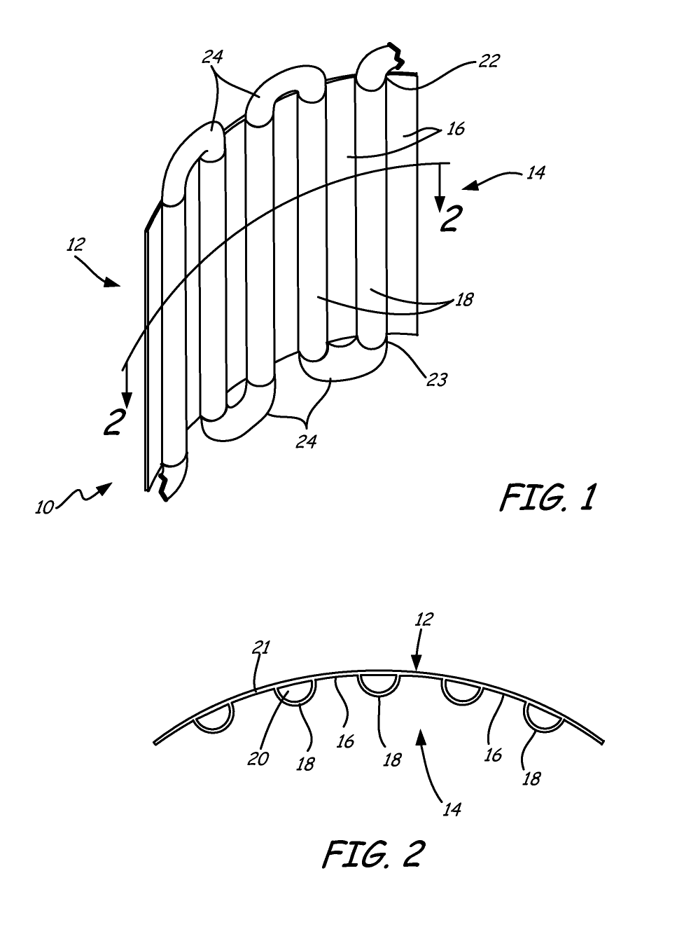

As shown in FIGS. 1 and 2, monolithic heat exchanger includes extrusion 10 (also referred to as cooling structure segment 10 or segment 10) with first side or surface 12, second side or surface 14 (with smooth portions 16 and raised portions 18), flow passages 20, fin portions 21, first end 22 and second end 23; and headers 24.

First (smooth) side 12 and second side 14 can be formed by shaping or extruding a profile to define coolant tubes 20 as a monolithic part. First side 12 and second side 14 can be formed of aluminum (including alloys) or another material depending on system requirements. Flow passages 20 are defined by first surface 12 and second surface 14 and extend from first end 22 to second end 23, generally parallel with each other. Headers 24 are welded onto first end 22 and second end 23 of cooling structure to join alternating flow passages 20. Alternatively, headers 24 can be bolted or secured by other means, or can join flow passages 20 in a different configuration, depending on system requirements. In this embodiment, extrusion 10 is curved slightly inward towards second side 14. Extrusion 10 can be joined with other extrusions modularly to form a cooling structure, which can be a complete cylinder radiator or a different shape depending on the application. The extrusion 10, and in particular the first side 12, may be placed in thermal contact with a heat producing source to be cooled.

Cross-sections of flow passages 20 are in the shape of a semi-circle. Cross-sections are extruded to define flow passage shape and size according to the amount of heat exchange required. Additional considerations for forming segment 10 cross-sections can be motor size for the pumping of fluid through flow passages 20 and size and shape of area or article needing heat exchange and space available for flow passages 20.

Cooling structure segment 10 acts as a heat exchanger to transfer heat from first surface 12 to fluid flowing through flow passages 20. Headers 24 connect flow passages 20 so that the plurality of flow passages 20 form a serpentine flow path to circulate a coolant.

By forming cooling structure segment 10 with an integrally extruded piece with semi-circular flow passages 20, cooling structure can efficiently act as a heat exchanger by eliminating barriers to heat exchange of past systems.

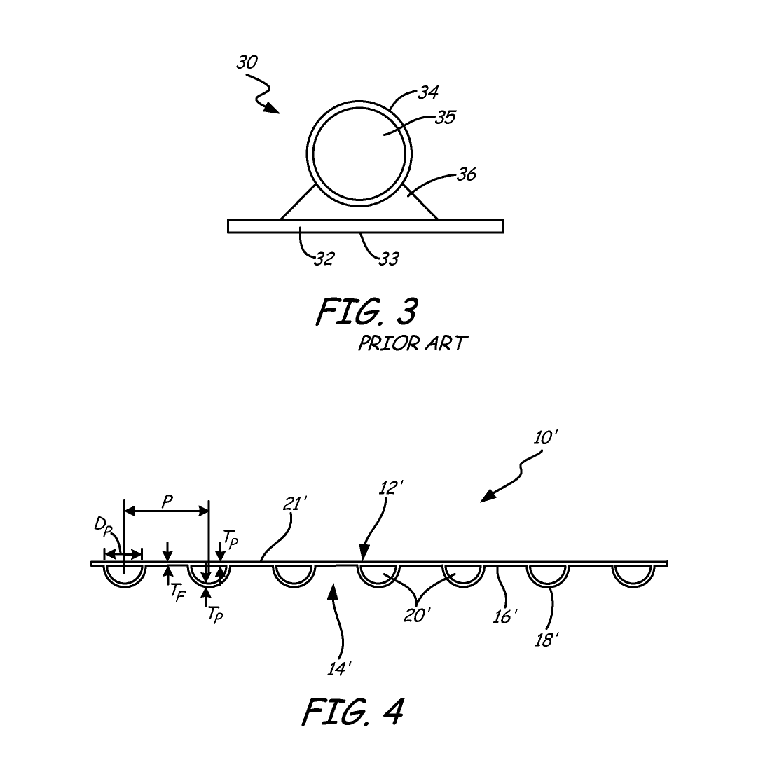

FIG. 3 shows a cross sectional view of a flow passage of prior art heat exchanger 30, and includes panel 32 with first surface 33, cylindrical tube 34 defining flow passage 35 and solder 36 connecting flow passage tube to panel 32. Connection material can be adhesive or another material depending on system requirements.

Heat is transferred from first surface 33 of panel 32 to fluid flowing through cylindrical tube 34. Solder 36 (or adhesive) in prior art systems acts as an additional barrier of resistance to transferring heat to fluid within flow passage 35. Additionally, flow passage 35 has a much smaller surface area exposed to panel 32 where it is absorbing heat from. This intrinsically causes less heat transfer than a system with a larger surface area for heat-transferring flow passage.

FIG. 4 shows a cross sectional view of a second embodiment of extrusion 10′ of a monolithic heat exchanger according to the present invention. FIG. 4 includes extrusion 10′ with first side 12′, second side 14′ (with smooth portions 16′ and raised portions 18′), flow passages 20′ and fin portions 21′. Dimensions shown include: diameter Dₚ of flow passages 20′, wall thickness T_{P} around flow passages 20′, wall thickness T_{F} in fin portions 21′ and pitch P between the flow passages 20′. Fluid flow through flow passages 20′ to transfer heat from first side 12′.

Flow passages 20′ are generally semi-circular and can have a diameter D_{P} of about 0.25 inches (6.35 mm) to about 1.1 inches (27.94 mm). Cross sections generally have two different wall thicknesses. Wall thickness around flow passages 20 T_{P} can be about 0.025 inches (0.635 mm). Wall thickness T_{F} in fin portions 21′ can be about 0.065 inches (1.651 mm). The thinner wall around flow passages 20 allows for enhanced heat transfer in those sections. Wall thickness around flow passages 20 T_{P} and Wall thickness T_{F} in fin portions 21′ are based on the geometry of flow passages 20,′ and can vary depending on system requirements. Pitch P can be about 7.5 inches (190.5 mm).

As seen in FIGS. 1-2 and 4, modular segment 10, 10′ of the current invention eliminates additional barriers to heat transfer of prior art systems (e.g., solder, adhesive) by forming extrusion 10, 10′ from one monolithic part. Heat exchanger extrusion 10 also provides more surface area for greater heat transfer to fluid by forming flow passages 20, 20′ in a semi-circular shape. This semi-circular cross-sectional shape gives fluid more contact with first side 12, 12′ to enhance heat transfer compared to the cylindrical flow passages 35 of past systems. Additionally, forming flow passages 20, 20′ semi-circular gives heat exchanger a lower profile, allowing use in applications with a limited amount of space for heat exchanger extrusion 10, 10′. Cooling structure segment 10, 10′ can be used as a space radiator (with thermal energy transferred from fluid flow inside flow passage 20, 20′ to fin portions 21, 21′) for a space vehicle, to cool electronics with high power densities or any other situations where heat exchange is needed.

While extrusion 10 is shown to have a curve, alternative embodiments can have a larger curve, smaller curve or no curve at all. Additionally, the size, number and shape of flow passages 20 may vary in different applications. While cross-sections in the embodiments shown in FIGS. 1, 2 and 4 are semi-circular, cross-sections in other embodiments can be different shapes that also provide a larger amount of surface area for heat transfer than cylinders of past systems (see FIG. 3).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat exchanger structure comprising:
a monolithic extrusion comprising:
a first end;
a second end;
a first, smooth side; and
a second side with a plurality of smooth portions alternating with a plurality of raised portions defining a plurality of parallel flow passages extending from the first end to the second end; and
a plurality of headers connecting the plurality of flow passages to form a flow path through the plurality of passages.

2. The structure of claim 1, wherein the extrusion is aluminum.

3. The structure of claim 1, wherein the plurality of flow passages have a cross section with a first surface parallel to the first side of the extrusion.

4. The structure of claim 3, wherein the width of the cross section is semi-circular.

5. The structure of claim 1, wherein the plurality of flow passages have an inner diameter of about 0.25 inches (6.35 mm) to about 1.1 inches (27.94 mm).

6. The structure of claim 1, wherein the headers connect alternating pairs of the plurality of flow passages.

7. The structure of claim 1, wherein the extrusion is a curved segment.

8. The structure of claim 1, wherein the flow path through the plurality of flow passages is serpentine.

9. A method of forming a heat exchanger structure comprising:
forming an extrusion as a monolithic part with a first end, a second end, a first, smooth side and a second side with a plurality of smooth portions alternating with a plurality of raised portions defining a plurality of elongated flow passages extending from the first end to the second end; and
joining the plurality of flow passages with a plurality of headers to form a flow path through the plurality of flow passages.

10. The method of claim 9, wherein the headers connect alternating pairs of the plurality of flow passages.

11. The method of claim 9, wherein the plurality of flow passages have a cross section with a first surface parallel to the first side of the structure.

12. The method of claim 11, wherein the cross section of the flow passages is a semi-circle.

13. The method of claim 9, wherein the structure is extruded as a curved segment.

14. The method of claim 13, and further comprising:
connecting multiple modular segments to form a full cylinder radiator.

15. The method of claim 13, wherein the plurality of flow passages have an inner diameter of about 0.25 inches (6.35 mm) to about 1.1 inches (27.94 mm).

16. A method of cooling comprising:
placing a cooling structure in thermal contact with a heat producing source, wherein the structure is formed by forming an extrusion as a monolithic part with a first end, a second end, a first, smooth side and a second side with a plurality of smooth portions alternating with a plurality of raised portions defining a plurality of flow passages extending from the first end to the second end; and
flowing a coolant through the plurality of flow passages, wherein the plurality of flow passages are joined at either end by a plurality of headers connecting pairs of flow passages to form a flow path.

17. The method of claim 16, wherein the extrusion is aluminum.

18. The method of claim 16, wherein the plurality of flow passages have a cross section that is a semi-circle.

19. The method of claim 18, wherein the each of the plurality of flow passages is parallel to the other flow passages.

20. The method of claim 16, wherein plurality of headers join alternating pairs of flow passages to form a serpentine flow path.
